(19) United States
(12) Patent Application Publication
(10) Pub. No.: US 2014/0218397 A1
(43) Pub. Date: Aug. 7, 2014

(54) METHOD AND APPARATUS FOR PROVIDING VIRTUAL DEVICE PLANNING

(71) Applicant: MCKESSON FINANCIAL HOLDINGS, Hamilton (BM)

(72) Inventors: Victor Rutman, Petah Tiqva (IL); Ifat Lavi, Mishmeret (IL); Ran Kornowski, Ramat-HaSharon (IL)

(73) Assignee: MCKESSON FINANCIAL HOLDINGS, Hamilton (BM)

(21) Appl. No.: 13/757,980

(22) Filed: Feb. 4, 2013

(51) Int. Cl. G06T 3/00

(52) U.S. Cl. CPC G06T 3/0068
USPC 345/632

(57) ABSTRACT

A method, apparatus and computer program product are therefore provided to enable virtual planning and selection of devices. In this regard, the method, apparatus, and computer program product may receive an image, where the image includes a set of image scale values. The image scale values may map the image size to real world units of measure. The image scale values may be used to scale the size of a model of a device, such that the model of the device may be superimposed on the image. The model of the device may be manipulated to view the relationship of the device model to the image to assist with selection of the proper device for a procedure. In this manner, a practitioner may visualize the device in the same scale as the image, so that the practitioner may be assured that the size and scale of the device is accurate.

### TECHNOLOGICAL FIELD

An example embodiment of the present invention relates generally to imaging applications, and, more particularly, to a method and apparatus for providing virtual device planning using a display.

### BACKGROUND

As technology advances, tools and devices used by skilled artisans have increased in complexity. Careful selection of the proper tool for the job is an important part of ensuring a successful result. Although the availability of these specialized tools, devices, components, and other resources may result in superior outcomes, the corresponding increase in complexity tends to result in a more and more involved planning phase as the user selects from among the array of available options.

Medical practitioners, in particular, must go through an involved planning phase before a procedure. Careful selection of tools and devices is a vital part of ensuring successful patient outcomes. Implants such as heart valve replacements must be selected for the particular patient within a tolerance of millimeters. The success of such an implant strongly depends on selection of an optimal device size and its proper positioning in the native valve. Failure to select the proper implant may result in complications or even the death of the patient. In order to accurately select the proper implant, the medical practitioner may follow certain protocols using pre-defined measurements and other patient factors, such as patient height, weight, or other factors. These techniques may also include estimating the proper size based on patient images, or using a ruler to measure the physical distance on an image and comparing with the size of the available implants. Some practitioners may even resort to holding up a particular implant against a 1-to-1 scale image of the patient to attempt to determine whether the implant is likely to be the correct size. Such methods rely on the ability of the practitioner to visualize the implant using only the implant itself and a flat medical image, thus resulting in an imprecise selection process.

### BRIEF SUMMARY

A method, apparatus and computer program product are therefore provided according to an example embodiment of the present invention in order to provide virtual planning and selection of devices. In this regard, the method, apparatus, and computer program product of an example embodiment may receive an image, where the image includes a set of image scale values. The image scale values may map the image size (e.g., in pixels) to real world units of measure. The image scale values may be used to scale the size of a model of a device, such that the model of the device may be superimposed on the image. The model of the device may be manipulated to view the relationship of the device model to the image to assist with selection of the proper device for a procedure. In this manner, a practitioner may visualize the device in the same scale as the image, so that the practitioner may be assured that the size and scale of the device is accurate. As different devices are selected, the size and shape of the model may change to conform to the particular selected device. In this manner, the proper device may be selected based on an accurate size and shape relationship with the image. Embodiments may also provide for alteration of the orientation of the device. The orientation of the device may be manually adjusted in the context of a single image. Embodiments may further allow for switching to an alternate view, such as provided by a second image. A relationship between the orientation of the first image and the second image may be determined, and the orientation of the device may be adjusted accordingly to keep a constant orientation with respect to the content of the image. For example, if the first image is a frontal view of a patient and the second image is a side view of the patient at 90 degrees to the first image, embodiments may detect the 90 degree relationship between the images and alter the orientation of the model by 90 degrees when switching between the images. Embodiments may further attempt to place the model in the corresponding location on the second image by mapping the position of elements of the first image with elements of the second image (e.g., screen pixel coordinates).

Embodiments may include a method. The method may include determining a first set of one or more scale settings from a first image, determining, using a processor, a size of a virtual representation of a device based on the first set of one or more scale settings, such that the size of the virtual representation of the device matches a scale of the first image, and displaying the virtual representation of the device in conjunction with the first image, such that the size of the virtual representation corresponds to the determined size of the virtual representation. The method may include providing an interface for manipulation of the virtual representation of the device. The manipulation may include articulating the virtual device at one or more articulation points. The method may also include determining one or more configuration settings for the device based on the manipulation. In yet further embodiments, the method may include suggesting a particular device based on the one or more configuration settings. The device may be selected from a list of a plurality of devices, and each of the plurality of devices may be associated with at least one virtual representation. The first set of one or more scale settings may include a ratio between a physical distance and a distance between a center of pixels of the first image. The first image may be stored in a stored in a Digital Imaging and Communications in Medicine (DICOM) format. The method may also include determining a first set of one or more scale settings from a first image, determining a size of a virtual representation of a device based on the first set of one or more scale settings, such that the size of the virtual representation of the device matches a scale of the first image, and displaying the virtual representation of the device in conjunction with the first image, such that the size of the virtual representation corresponds to the determined size of the virtual representation.

Further embodiments may include an apparatus comprising processing circuitry. The processing circuitry may be configured to determine a first set of one or more scale settings from a first image, determine a size of a virtual representation of a device based on the first set of one or more scale settings, such that the size of the virtual representation of the device matches a scale of the first image, and display the virtual representation of the device in conjunction with the first image, such that the size of the virtual representation corresponds to the determined size of the virtual representation. The processing circuitry may be further configured to provide an interface for manipulation of the virtual representation of the device. The manipulation may include articulating the virtual device at one or more articulation points. The processing circuitry may be further configured to determine one or more configuration settings for the device based on the manipulation. The first set of one or more scale settings may include a ratio between a physical distance and a distance between centers of pixels of the first image. The first image may be in a stored in a Digital Imaging and Communications in Medicine (DICOM) format. In some embodiments, the processing circuitry may be further configured to determine a first set of one or more scale settings from a first image, determine a size of a virtual representation of a device based on the first set of one or more scale settings, such that the size of the virtual representation of the device matches a scale of the first image, and display the virtual representation of the device in conjunction with the first image, such that the size of the virtual representation corresponds to the determined size of the virtual representation.

Yet further embodiments may include a computer program product comprising at least one non-transitory computer-readable storage medium bearing computer program instructions embodied therein for use with a computer. The computer program instructions may include program instructions configured to determine a first set of one or more scale settings from a first image, determine a size of a virtual representation of a device based on the first set of one or more scale settings, such that the size of the virtual representation of the device matches a scale of the first image, and display the virtual representation of the device in conjunction with the first image, such that the size of the virtual representation corresponds to the determined size of the virtual representation. The program instructions may be further configured to provide an interface for manipulation of the virtual representation of the device. The manipulation may include articulating the virtual device at one or more articulation points. The program instructions may be further configured to determine one or more configuration settings for the device based on the manipulation.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention;

FIG. 2 is a block diagram of a data flow for generating a virtual visualization of a device in accordance with an example embodiment of the present invention;

FIG. 3 is a block diagram of a device library in accordance with an example embodiment of the present invention;

FIG. 4 is an illustration of an example interface for providing a virtual visualization of a device in accordance with an example embodiment of the present invention;

FIG. 5 is a flow diagram of an example method for providing virtual device planning in accordance with an example embodiment of the present invention; and

FIG. 6 is a flow diagram of an example method for maintaining a consistent virtual device orientation in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided in accordance with an example embodiment of the present invention in order to provide virtual planning and selection of devices. In this regard, a method, apparatus and computer program product of an example embodiment may display a virtual model of a selected device on an image. The size, shape, orientation, and scale of the virtual model may be determined by size or other scale values associated with the image. For example, a scale value may be provided by a calibration factor of an image, where the calibration factor associates a width of a pixel to a particular physical unit of measure. A virtual model may be associated with a particular physical size, and pixels of the image may be associated with a particular physical scale. The virtual model may be adjusted so that relationship between pixel size of a displayed virtual model and a physical scale matches the relationship between the pixel size of the image and the physical scale of the image.

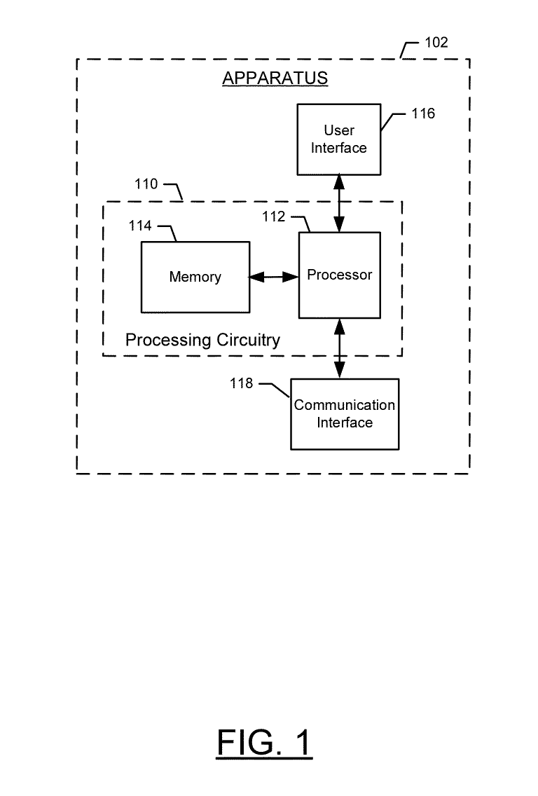

FIG. 1 illustrates a block diagram of an apparatus 102 in accordance with some example embodiments. The apparatus 102 may be any computing device capable of creating a display including a scaled virtual model. In some particular embodiments, the apparatus 102 may be configured to perform or otherwise assist with medical diagnostic and/or imaging operations. For example, the apparatus 102 may be implemented on a computing device that may be configured to access and display images stored in a Digital Imaging and Communications in Medicine (DICOM) format. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 102 is implemented on a server, aspects of the user interface 116 may be limited, or the user interface 116 may even be eliminated. For example, the apparatus 102 may act as a server or host device, with a user interface provided by a client application.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. For example, the apparatus 102 may obtain an image of a patient, and allow a user to position a virtual model of a medical device relative to the image. Based on the positioning of the virtual model, instructions may be generated by the apparatus 102 and transmitted to another computing device for display, configuration, or other output. For example, the positioning of the virtual model may control a robotic arm positioning a device during a surgical procedure, or a display may recommend a certain configuration of a medical device used by a physician performing a medical procedure (e.g., a device size setting). As another alternative, the positioning of the virtual model may control an imager or imaging scanner, such as a mobile fluoroscopic system or “c-arm”. Such a system may utilize device positioning to determine and/or optimize a location and/or configuration for performing medical imaging operations. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

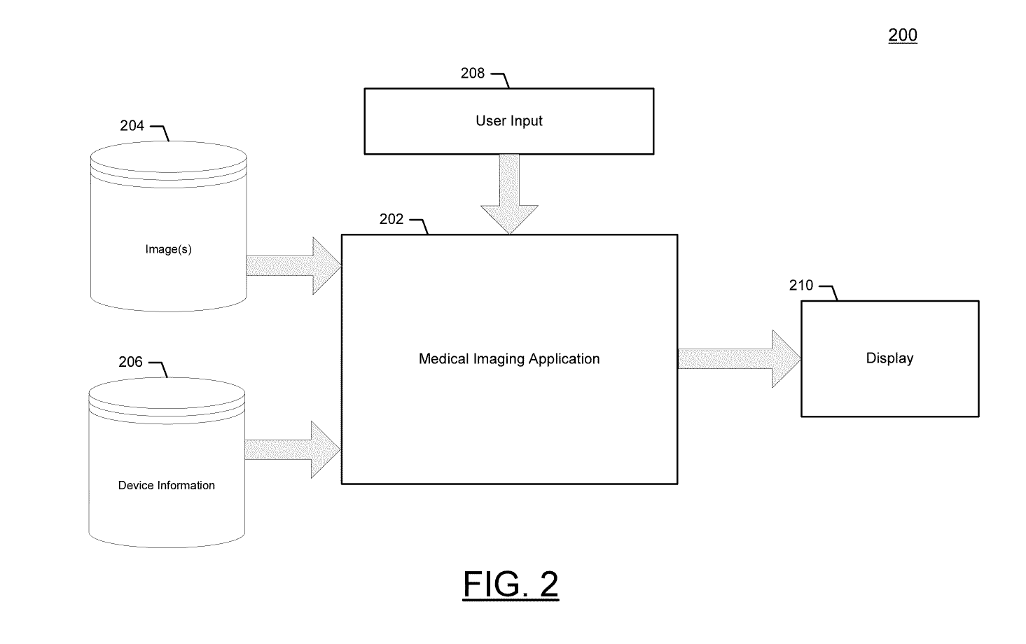

FIG. 2 is a block diagram of a process flow for providing virtual device planning in accordance with an example embodiment of the present invention. The process flow 200 depicts a series of communications that allow for generation of a virtual model of a device to be appropriately scaled for display in conjunction with an image. Although the instant example embodiment describes the use of a medical imaging application 202, such as an application executing via the apparatus 102 described with respect to FIG. 1, the virtual planning system described could also be used in conjunction with fields other than medicine, such as engineering, architecture, or any other field which may benefit from the use of scaled virtual models in conjunction with images. The medical imaging application 202 may extract an image scale from an image 204, generate a virtual model of a device using the image scale and device measurements stored in the device information 206, and create a virtual planning environment using the virtual model and the image for display on the display 210.

The medical imaging application 202 may receive data, including but not limited to images 204, device information 206, and user input 208. The data may be received from various sources, such as internal or external memory, one or more user interface devices (e.g., mouse, keyboard, touchscreen), one or more sensors (e.g., a camera), or other sources. The medical imaging application 202 may use the images 204, the device information 206, and the user input 208 to generate a virtual device planning environment for output to a display 210. In some embodiments, the display 210 may also function to provide user input 208, such as in the case of a touchscreen.

The images 204 may include one or more images stored in various formats, such as the DICOM format. The images 204 may be associated with certain metadata, such as an image scale (e.g., physical distance within the patient between the center of each pixel), image orientations (e.g., front view, side view, rear view, etc.), image types (e.g., x-ray, Computed Tomography (CT) scan, Magnetic Resonance Imaging (MRI), etc.), or the like. The image metadata may be provided to the medical imaging application 202 in addition to or in conjunction with the image. In some embodiments, the image metadata is encoded in the image itself as a single file.

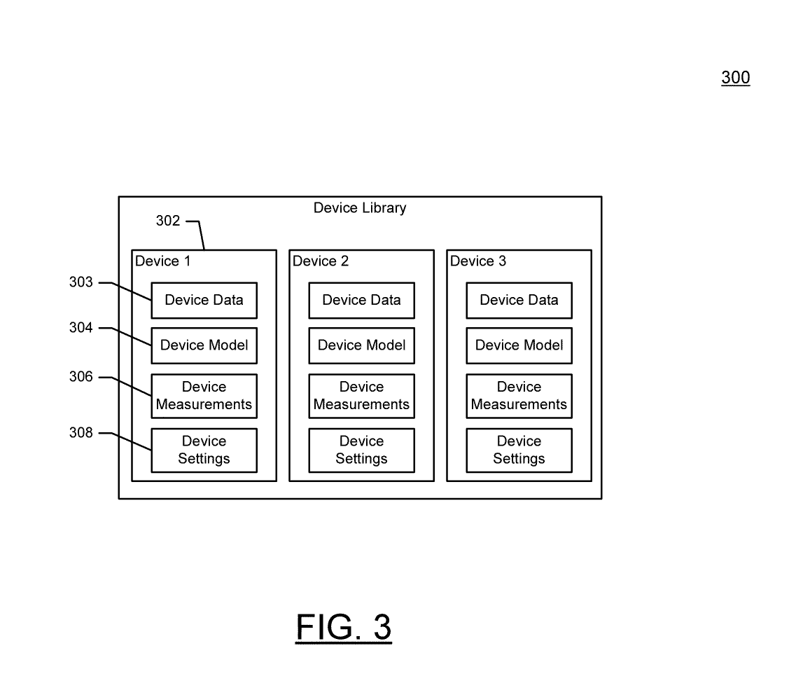

The device information 206 provided to the medical imaging application 202 allows the medical imaging application 202 to generate a virtual model of one or more devices that are scaled to the size and format of a particular image, such as one of the images 204. The device information 206 may include information such that the medical imaging application can render a three dimensional model of a device, scale the size of the three dimensional model to the scale of the image 204, and allow manipulation of the virtual model of the device to provide for a virtual planning environment. For example, the device information 206 may include a three dimensional model of the device, one or more measurements associated with the device, and a set of device settings or other characteristics. An example of the content of the device information 206 is described further below with respect to FIG. 3.

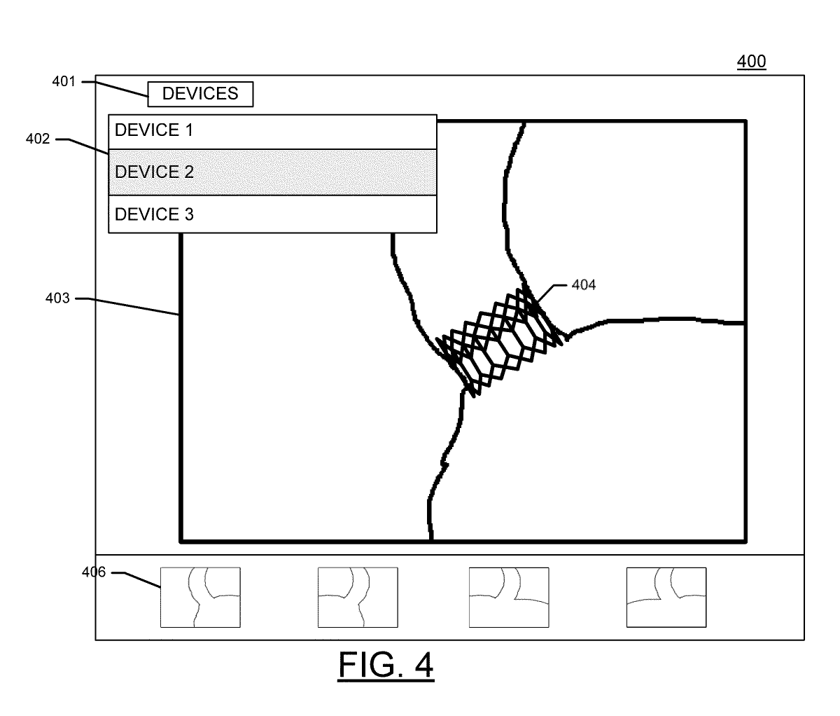

The medical imaging application 202 may also receive user input 208. The user input 208 may allow for selection of a particular image or set of images, selection of a particular device, and placement and manipulation of the particular device in a virtual planning environment. The user input may be received for one or more user interfaces, such as the user interface 116 described with respect to FIG. 1. An example interface for receiving such input is described further below with respect to FIG. 4.

FIG. 3 is a block diagram of a device library 300 in accordance with an example embodiment of the present invention. The device library 300 may include one or more device entries 302, each device entry 302 defining one or more devices for use with a virtual planning environment. Each device may have a corresponding entry in the device library 300, and an application, such as the medical imaging application 202, may request the device entry from the device library 300 in response to selection of a particular device for visualization in the virtual planning environment. In some embodiments, the device library 300 may be a single file or database, while in other embodiments the device library 300 may be implemented as a series of files or databases. Each device entry 302 may be associated with a single file, or the device entries may be associated with multiple files. The device library 300 may maintain a single index file with a list of all devices defined in the library.

Each device entry 302 may include device data 303, a device model 304, one or more device measurements 306, and one or more device settings 308. The device data 303 may include various text parameters, numerical values, and other data associated with the particular device, such as a device name or other identifier, a device version number, a device entry creation date, or the like. The device data 303 may further indicate one or more relevant image types, imaging devices, medical procedures, or other data that may be used to determine if the particular device is relevant to a particular image or study. Device models 304 may be three-dimensional representations of real-world devices that have been encoded into a three-dimensional format. For example, a modeler or artist may generate a wire-frame model of a device to use as the device model 304. The device model 304 may be compatible with various well-known three dimensional modeling techniques. For example, the device may include a mesh and one or more textures suitable for rendering in an OpenGL graphics format. The device model 304 may be provided to a separate application, such as the medical imaging application, for rendering.

The device measurements 306 may provide one or more measurement values associated with each device entry 302. For example, the device measurements 306 may include lengths, widths, and/or heights of various elements of the device. These device measurements 306 may be used in conjunction with an image scale derived from a separate image file to determine a relative size of the device model 304 once rendered in the virtual planning environment. The device measurements may be provided as multiple measurements (e.g., separate measurements for length, width, and height), or as a single measurement from which relative scale values may be derived from the size of the model (e.g., the device is 10 mm wide and twice as long as it is wide, therefore the length may be calculated as 20 mm).

The device entry 302 may further include one or more device settings 308. The device settings 308 may include various other device data that is relevant to creation of the virtual representation of the device. For example, a particular device may have a property that allows the device to be stretched, opened, other otherwise configured when placed. The property may indicate various points (e.g., vertices of the device model 304) of motion or articulation that may be manipulated in the virtual environment. The device settings may also specify how the device responds to various interactions performed in the virtual planning environment (e.g., the device elongates when dragged in a certain manner, or the device widens when right clicked).

FIG. 4 is an illustration of an example interface 400 for providing a virtual visualization of a device in accordance with an example embodiment of the present invention. The interface 400 depicts an image 403 with a virtual device 404 displayed on the image 403. The virtual device 404 may be selected via a device selection menu 402. The device selection menu 402 may include information about each device available in the device library, such as the name of the device, the manufacturer model number of the device, or the like. In some embodiments, the list of devices available in the device selection menu 402 may be determined based on relevance to the image. For example, if image metadata indicates that the image is an image of a patient heart valve, the device selection menu 402 may be populated with devices that are associated with heart valves (e.g., replacement valves). In this manner, the device selection menu 402 may provide the user with a choice of relevant devices while excluding devices that are not relevant to the image being examined (e.g., an artificial hip would not be appropriate for display on an image of a heart valve). The device selection menu 402 may be invoked upon selection of a button 401. In the present example, a device known as “Device 2” has been selected from the device selection menu, and the virtual model 404 of the device is visible as superimposed on the image 403.

Upon selection of the device from the device selection menu 402, the virtual model of the device may be created by the display application and presented as superimposed or overlaid on the image 403. As described above, the size of the device may be determined based on a scale value associated with the image. For example, the user may select a particular image by executing an “open” operation on a particular study or image file. The display application may access the selected study or image file and identify a scale value (e.g., a physical distance corresponding to the distance between the centers of pixels in the image). The scale value may be used to determine the size of virtual models of devices selected via the device selection menu 402. For example, if the size of a particular device is 20 mm in width, and the image has a scale value of 0.1 mm between the centers of adjacent pixels, then the device virtual model for the particular device may be shown as having a width of 200 pixels when projected onto the image.

Once the device virtual model 404 has been scaled and displayed on the screen, the virtual model may be manipulated by the user. For example, the device virtual model may be dragged about the screen using a mouse cursor, a touch screen, or any other interface device. In some embodiments, the device may be manipulated by the user in other ways, such as expanding a device that includes one or more articulation points for expansion. The application may further allow for modification of the device orientation. For example, the device may be rolled or pitched across various axes.

In the present example, the image 403 depicts an aortic valve, and the selected device corresponds to a replacement aortic valve designed to fit inside of the depicted aortic valve. As such, a medical practitioner selecting such a device must select a device that matches the size of the patient's heart valve. Because the virtual device model 404 is scaled to the same size scale as the image 403, the practitioner may manipulate the virtual model to be in the same position that the real-world device would be positioned during a medical procedure. The practitioner may thus determine whether a particular device is a proper fit using only the virtual representation. In some embodiments, the practitioner may confirm positioning of a selected device, and the interface 400 may provide a set of measurements or values associated with said positioning. Where the medical device has multiple configuration settings, the practitioner may manipulate the virtual model to configure the device, and, upon confirming the positioning, receive a set of configuration values that represent the manipulations performed by the practitioner to ensure proper configuration of the device. For example, if the device has a number of size settings, the practitioner may drag or stretch the device to ensure a proper fit in the area depicted by the image. Upon selecting the proper size, the practitioner may indicate as such to the interface and receive a set of measurements corresponding to the size of the device after manipulation. For example, the practitioner may be provided with a set of measurements indicating the device should be configured to a radius of 15.7 mm and a length of 28 mm. Of course, any other set of measurements and values could also be configured for the device, as appropriate for the particular type of the device.

In some embodiments, the interface 400 may further include icons for selection of additional images 406. These images may be associated with different views from the same study, such as presenting a different viewing angle of the same patient. The viewing angle may be associated with each image, such that the relationship of the viewing angle may be determined by comparing the angles of each image. For example, a first image may view a patient from an anterior position facing the front of the patient, and a second image may view the patient from a lateral angle, facing the patient's right side. As such, the application may determine that the first image and the second image are offset by a 90 degree rotation. In response to selection of the second image after placement of the virtual device in the first image, the virtual model may be rotated by the same 90 degree angle to show a consistent positioning of the virtual model across images. Additionally or alternatively, relationships between the first and second image may be used to automatically position the virtual device in the same location relative to the patient in the second image as in the first image.

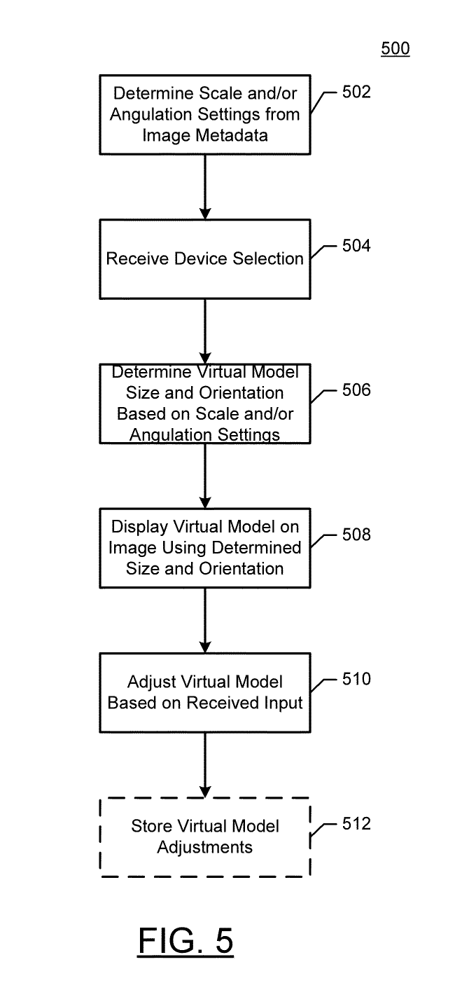

FIG. 5 is a flow diagram of an example method 500 for providing virtual device planning in accordance with an example embodiment of the present invention. The method 500 functions to receive a selection of a particular image and a particular device, and to generate a virtual model of the selected device in relation to the scale of the particular image. In this manner, the virtual model may be used in conjunction with the display of the image to determine the relationship the device associated with the virtual model has with the physical object depicted in this image. For example, the method 500 may be used in a medical imaging scenario to determine if a particular medical device is an accurate match with a particular patient by comparing the virtual model of the device with a medical image of the patient. The method 500 may be performed by, for example, a medical imaging application, such as the medical imaging application 202 described with respect to FIG. 2. The method 500 may be executed by a computing device, such as the apparatus 102 described with respect to FIG. 1.

At action 502, scale and/or angulation settings are determined using image metadata. The image may be selected as a file or a part of a study. For example, a medical practitioner may open a file for a user's x-ray image or CT scan. The scale settings may be associated with the image (e.g., as embedded metadata), the study, or as any set of metadata otherwise associated with the image. The scale settings may include a physical width between the centers of adjacent pixels. In some embodiments, the scale setting may be presented as a single value, or in other embodiments the scale may be multiple values, such as in circumstances where images have different pixel widths along different axes (e.g., widescreen aspect ratios). The scale settings may further include information about the orientation of the image, such as whether the image is a front view, a side view, a top-down view, or the like. Angulation settings may be determined based on an orientation of the image (e.g., anterior, posterior, lateral) as derived from metadata associated with the image.

At action 504, a selection of a particular device is received. For example, a device may be selection using a device selection window as described above with respect to FIG. 4. At action 506, a device size and/or orientation are determined using the scale and/or angulation settings. The selection of the device may include receiving one or more size values associated with the device and a virtual model of the device. The scale settings determined at action 502 may be used in conjunction with the device size values to alter the size of the virtual model such that the virtual model is displayed with the same scale as the image from which the scale settings were derived at action 502, and the angulation settings may be used in conjunction with a device model to adjust the initial orientation of the device to match the orientation of the image.

At action 508, a virtual model of the device is displayed using the size and/or orientation derived at action 506. The virtual model may be superimposed or otherwise overlaid on the image from which the scale settings were derived at action 502. The virtual model may be rendered by a three-dimensional rendering application using a graphics application programming interface, such as Open Graphics Language (OpenGL).

At action 510, the virtual model may be adjusted based on received input. Once the virtual model is displayed, the user may manipulate the virtual model to ensure correct device configuration and placement. For example, the user may drag the virtual model about the screen to ensure a proper fit between the device and the physical object depicted by the image. The virtual model may be manipulated in various directions and along various axes. For example, the user may alter the yaw, pitch, or roll of the device, or increase or decrease the size of the device if the device supports a configurable size. Some devices may have particular points of articulation or other settings that are also able to be manipulated by the user.

At action 512, the position, orientation, and other size or shape features of the virtual model may be stored as configuration settings for the device. For example, the user may manipulate a virtual model of a device to match a particular aspect of the image (e.g., a heart valve may be manipulated to match the size of a patient's aorta), and the size, orientation, and other configuration settings may be stored to allow the user to select the appropriate device. In some embodiments, the interface may suggest a particular device, model number, part number, or the like based on the positioning and manipulation of the virtual model. For example, if the virtual model of the valve is placed such that the valve has a width of 20 mm, then the interface may suggest a replacement valve model number that corresponds to a valve with a width of 20 mm. In some embodiments, the adjustments for the device may not be stored, as the user may manually select a particular device via trial-and-error.

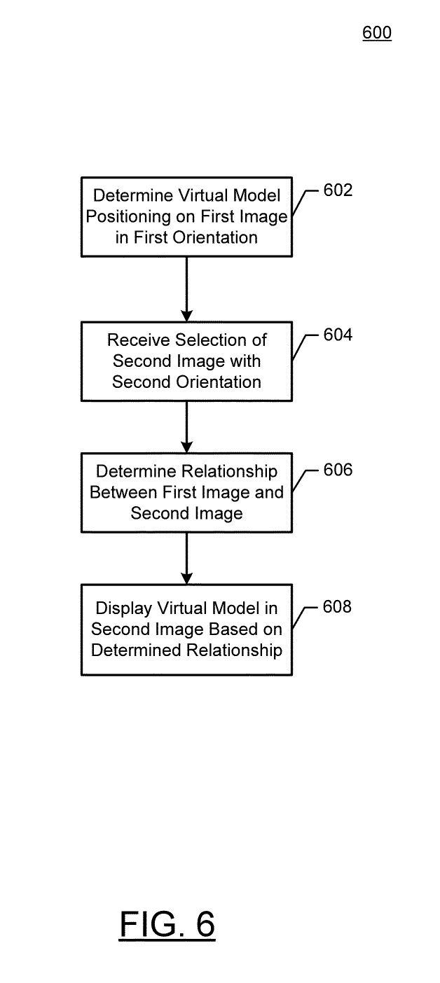

FIG. 6 is a flow diagram of an example method 600 for maintaining a consistent virtual device orientation in accordance with an example embodiment of the present invention. As described above, in addition to presenting a scaled virtual model for planning in a single image, embodiments of the invention may also present a consistent display of the virtual model across multiple images. A given study may present multiple images of the same object or person. For example, a medical study may include views of the patient from the front, rear, sides, and top. The method 600 may provide for a consistent device size and orientation as different images are displayed. In this manner, a user may be afforded more accurate placement of the device, as the use of multiple images may assist with placement of a three-dimensional virtual model in a three-dimensional space represented by a series of two-dimensional images. The method 600 may be performed by, for example, a medical imaging application, such as the medical imaging application 202 described with respect to FIG. 2. The method 600 may be executed by a computing device, such as the apparatus 102 described with respect to FIG. 1.

At action 602, positioning is determined for a virtual device in relation to a first image. For example, a virtual device may be positioned on a first image as described above with respect to FIG. 5. The virtual device may be associated with a particular size and orientation with respect to the first image.

At action 604, a second image is selected. The second image may be part of the same study as the first image. For example, the first image might represent an image taken from an anterior view of a patient, while the second image might represent an image taken from a lateral view of the patient. The second image may be associated with a separate set of image metadata than the first image for derivation of scale and/or angulation information, or image metadata for the second image may be stored in the same location as the image metadata for the first image.

At action 606, a relationship between the first image and the second image is determined. The relationship may include the relationship between the orientation (e.g., anterior view vs. lateral side view), the relative size scale of the image (e.g., 0.1 mm per pixel vs. 0.2 mm per pixel), or locations in the image (e.g., determining a reference point displayed in both images to identify corresponding features in the images). The relationship may be determined by comparing image metadata for the first image with image metadata for the second image, such as by comparing scale and angulation settings for each image to determine a difference in scale and a difference in angulation, or, in some embodiments, the relationship may be determined by utilizing the image metadata of the second image directly.

At action 608, the determined relationship is used to alter the display of the virtual model so that the virtual model display is consistent across images. For example, if the relationship between the two images is a 90 degree rotation from the first image to the second image, then the position of the model would also be rotated by 90 degrees from the first position when selecting the second image. As a further example, if the first image has a scale of 0.1 mm per pixel and the second image has a scale of 0.2 mm per pixel, then the scale of the virtual model would be reduced when switching to the second image. As yet another example, the virtual model may be moved in the second image to correspond to the same location occupied by the virtual model in the first image. In this manner, the virtual model may be displayed consistently across images, based on the size, location, and orientation of the virtual model as placed in the first image.

It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining a first set of one or more scale settings from a first image;
determining, using a processor, a size of a virtual representation of a device based on the first set of one or more scale settings, such that the size of the virtual representation of the device matches a scale of the first image; and
displaying the virtual representation of the device in conjunction with the first image, such that the size of the virtual representation corresponds to the determined size of the virtual representation.

2. The method of claim 1, further comprising providing an interface for manipulation of the virtual representation of the device.

3. The method of claim 2, wherein the manipulation comprises articulating the virtual device at one or more articulation points.

4. The method of claim 2, further comprising determining one or more configuration settings for the device based on the manipulation.

5. The method of claim 4, further comprising suggesting a particular device based on the one or more configuration settings.

6. The method of claim 1, wherein the device is selected from a list of a plurality of devices, each of the plurality of devices being associated with at least one virtual representation.

7. The method of claim 1, wherein the first set of one or more scale settings comprise a ratio between a physical distance and a distance between a center of pixels of the first image.

8. The method of claim 1, wherein the first image is stored in a stored in a Digital Imaging and Communications in Medicine (DICOM) format.

9. The method of claim 1, further comprising:
determining a first set of one or more scale settings from a first image;
determining a size of a virtual representation of a device based on the first set of one or more scale settings, such that the size of the virtual representation of the device matches a scale of the first image; and
displaying the virtual representation of the device in conjunction with the first image, such that the size of the virtual representation corresponds to the determined size of the virtual representation.

10. An apparatus comprising processing circuitry configured to:
determine a first set of one or more scale settings from a first image;
determine a size of a virtual representation of a device based on the first set of one or more scale settings, such that the size of the virtual representation of the device matches a scale of the first image; and
display the virtual representation of the device in conjunction with the first image, such that the size of the virtual representation corresponds to the determined size of the virtual representation.

11. The apparatus of claim 10, wherein the processing circuitry is further configured to provide an interface for manipulation of the virtual representation of the device.

12. The apparatus of claim 11, wherein the manipulation comprises articulating the virtual device at one or more articulation points.

13. The apparatus of claim 11, wherein the processing circuitry is further configured to determine one or more configuration settings for the device based on the manipulation.

14. The apparatus of claim 10, wherein the first set of one or more scale settings comprise a ratio between a physical distance and a distance between centers of pixels of the first image.

15. The apparatus of claim 10, wherein the first image is stored in a Digital Imaging and Communications in Medicine (DICOM) format.

16. The apparatus of claim 10, wherein the processing circuitry is further configured to:
determine a first set of one or more scale settings from a first image;
determine a size of a virtual representation of a device based on the first set of one or more scale settings, such that the size of the virtual representation of the device matches a scale of the first image; and
display the virtual representation of the device in conjunction with the first image, such that the size of the virtual representation corresponds to the determined size of the virtual representation.

17. A computer program product comprising at least one non-transitory computer-readable storage medium bearing computer program instructions embodied therein for use with a computer, the computer program instructions comprising program instructions configured to:
determine a first set of one or more scale settings from a first image;
determine a size of a virtual representation of a device based on the first set of one or more scale settings, such that the size of the virtual representation of the device matches a scale of the first image; and
display the virtual representation of the device in conjunction with the first image, such that the size of the virtual representation corresponds to the determined size of the virtual representation.

18. The computer program product of claim 17, wherein the program instructions are further configured to provide an interface for manipulation of the virtual representation of the device.

19. The computer program product of claim 18, wherein the manipulation comprises articulating the virtual device at one or more articulation points.

20. The computer program product of claim 18, wherein the program instructions are further configured to determine one or more configuration settings for the device based on the manipulation.
